(19) United States
(12) Patent Application Publication
(10) Pub. No.: US 2017/0264581 A1
(43) Pub. Date: Sep. 14, 2017

(54) Method of Organizing Emails

(71) Applicant: Ankush Dave, DAYTON, NJ (US)

(72) Inventor: Ankush Dave, DAYTON, NJ (US)

(21) Appl. No.: 15/457,218

(22) Filed: Mar. 13, 2017

Related U.S. Application Data
(60) Provisional application No. 62/307,859, filed on Mar. 14, 2016.

(51) Int. Cl. H04L 12/58; G06Q 10/10

(52) U.S. Cl. CPC H04L 51/16; H04L 51/22; G06Q 10/107; H04L 51/14; G06Q 10/1093

(57) ABSTRACT

A method of organizing emails is used to present email messages in an easily accessible and organized manner through the use of a calendar format. The method is performed by a system which includes a personal computing device and at least one remote server. The remote server manages a virtual calendar which organizes a plurality of email messages exchanged between the remote server and the personal computing device. The virtual calendar includes a plurality of day slot used for sorting each email message by day. Each of the plurality of email messages includes contact information and a timestamp. When a newest message is sent or received, the timestamp is compared with the plurality of day slots to assign the newest email to a matching day slot. Similarly, the contact information is used to assign the newest message to a corresponding contact slot within the matching day slot.

The current application claims a priority to the U.S. Provisional Patent application Ser. No. 62/307,859 filed on Mar. 14, 2016.

### FIELD OF THE INVENTION

The present invention relates generally to email management systems. More specifically, the present invention relates to methods of organizing emails for display in a calendar format.

### BACKGROUND OF THE INVENTION

Conventional email interfaces used for managing sent and received emails can be awkward or even confusing to use. Through sorting emails with a plurality of folders, users may often find it difficult to find emails they are looking for. Common email interfaces sort email messages chronologically without grouping emails from the same contact unless multiple emails are contained within an email thread. If a user forgets to use the “reply” option when sending an email or chooses to compose a new message, it can be difficult for a user to recover the context of a previous conversation because the previous email messages will not link to the new message. As a result, the inability of a user to find specific emails can lead to confusion and lost productivity.

Accordingly, there is a present need for a new and more intuitive method of organizing email messages. The present invention organizes email messages based on the date and time each email message is exchanged. The email messages are then displayed through a virtual calendar. This format allows users to easily see which day an email message was sent or received on. Furthermore, email messages are sorted based on the email address, or contact, through which emails are being exchanged. This is done, regardless of if multiple messages are a part of a larger email chain. Email messages sent from specific contacts may also be prioritized as “favorites” for the sake of convenience. By sorting emails in such a manner, the virtual calendar may be easily navigated to quickly access a desired email message.

### BRIEF DESCRIPTION OF THE DRAWINGS

FIG. 1 is a schematic diagram of the system used by the present invention.

FIG. 2 is a flowchart for the overall process of the present invention.

FIG. 3 is a flowchart describing the steps of assigning the newest slot to a matching contact slot.

FIG. 4 is a flowchart describing the steps of chronologically organizing the newest message and at least one previous message.

FIG. 5 is a flowchart describing the steps of displaying the contact information within the matching contact slot.

FIG. 6 is a flowchart describing the steps of generating a new contact slot for the newest message.

FIG. 7 is a flowchart describing the steps of displaying the contact information within the new contact slot.

FIG. 8 is a flowchart describing the steps of alphabetically organizing a plurality of daily contact slots.

FIG. 10 is a flowchart describing the exchange of the plurality of emails, wherein the newest message is sent through the remote server to the personal computing device.

FIG. 11 is a flowchart describing the exchange of the plurality of emails, wherein the newest message is sent from the personal computing device to the remote server.

FIG. 12 is a flowchart describing the steps of displaying a specific day slot.

FIG. 13 is a flowchart describing the steps of displaying a specific contact slot.

FIG. 14 is a flowchart describing the steps of displaying a specific message.

### DETAILED DESCRIPTION OF THE INVENTION

All illustrations of the drawings are for the purpose of describing selected versions of the present invention and are not intended to limit the scope of the present invention.

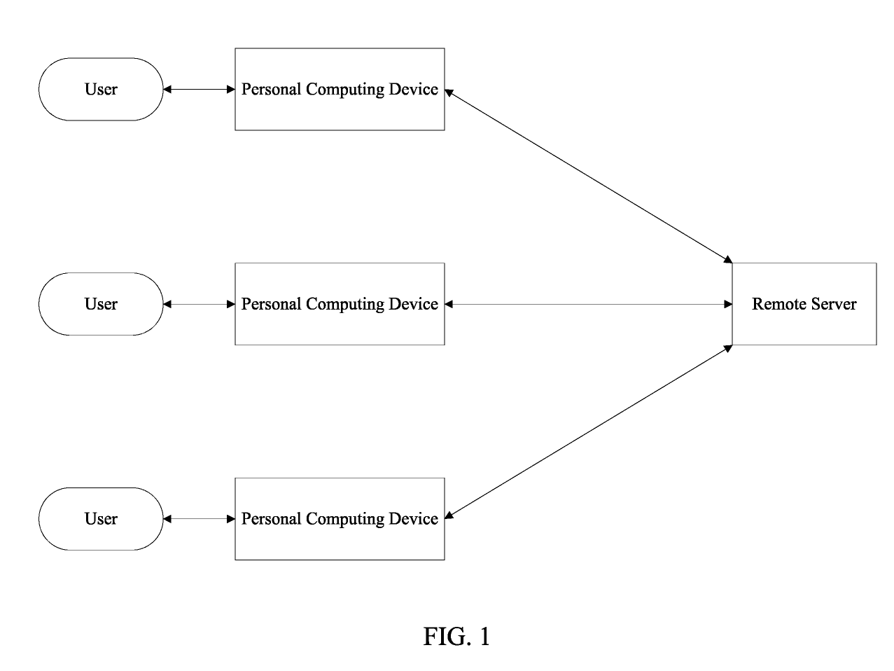

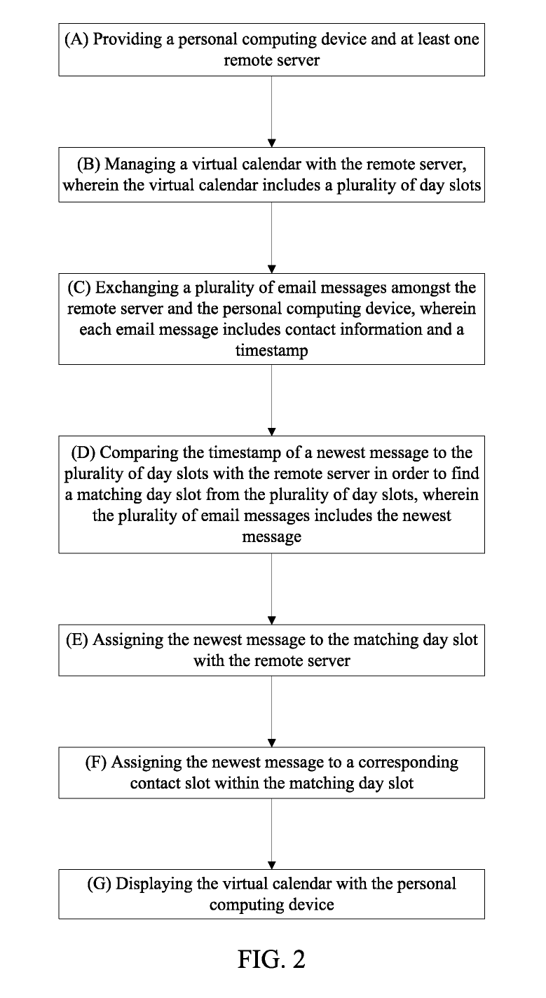

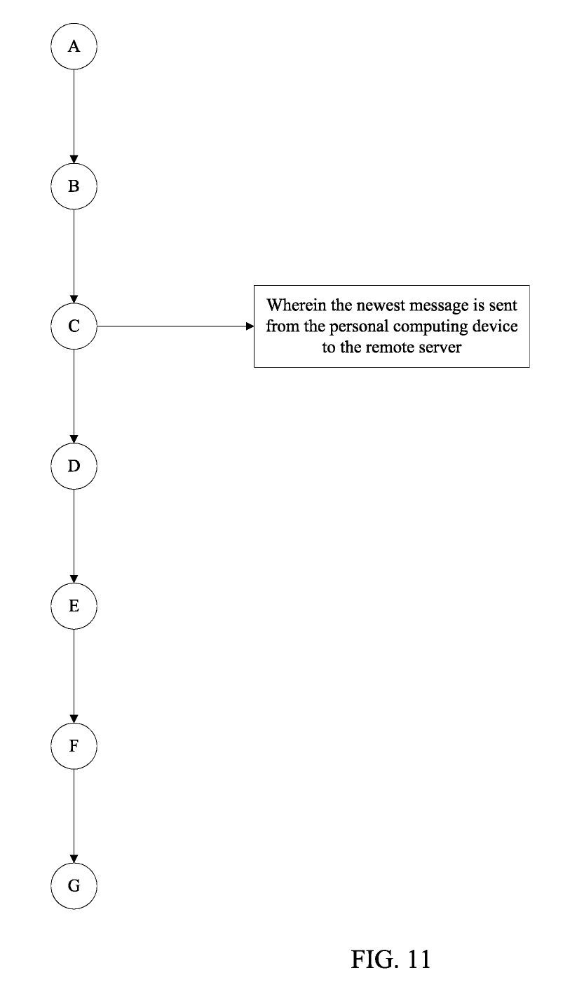

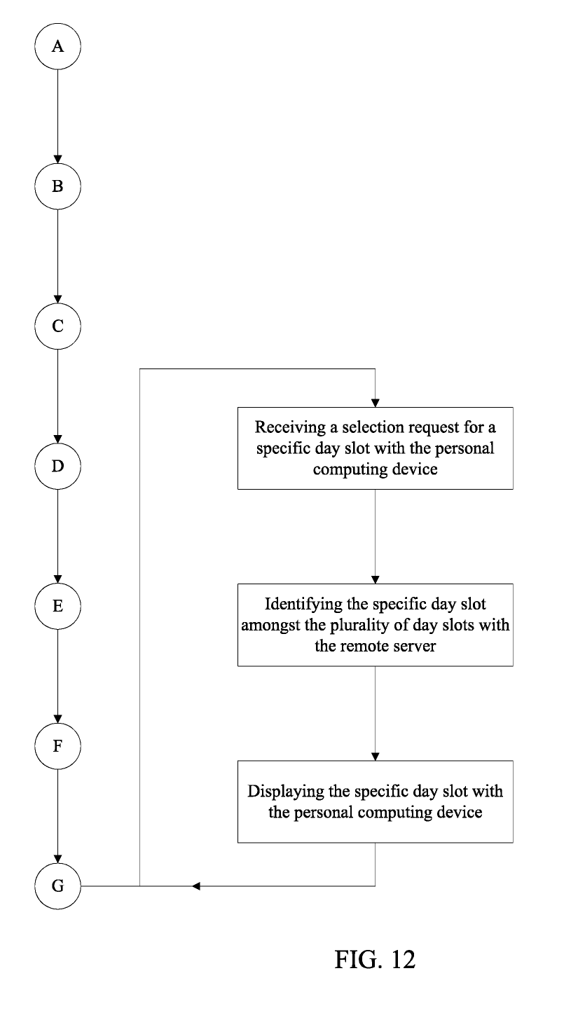

With reference to FIGS. 1-2, the present invention is a method of organizing emails which is ergonomically designed to improve the user experience and minimize time spent locating individual email messages. The method of the present invention is performed by a system which comprises a personal computing device and at least one server (Step A). The remote server and the personal computing device communicate with each other in order to exchange and display email messages. A virtual calendar is managed with the remote server, wherein the virtual calendar includes a plurality of day slots (Step B). A plurality of email messages is exchanged amongst the remote server and the personal computing device, wherein each email message includes contact information and a timestamp (Step C). Each day slot of the virtual calendar is used to organize the plurality of email messages based on when each individual email message is sent or received. In reference to FIGS. 11-12, the newest message may be either sent through the remote server to the personal computing device or sent from the personal computing device to the remote server.

In reference to FIG. 2, a newest message either sent or received through the remote server is first sorted based on the when the newest message is exchanged. The remote server compares the timestamp of the newest message to the plurality of day slots in order to find a matching day slot from the plurality of day slots, wherein the plurality of email messages includes the newest email message (Step D). Once the matching day slot is found, the remote server assigns the newest message to the matching day slot (Step E). In order to further organize the newest message, the contact information of the newest message is used to separate messages sent to or received from different people. After analyzing the contact information of the newest message, the newest message is assigned to a corresponding contact slot within the matching day slot (Step F). After the newest message is properly organized, the virtual calendar is displayed with the personal computing device (Step G). Because the virtual calendar is managed by the remote server, each email message may be organized regardless of whether a user accesses the virtual calendar with the personal computing device.

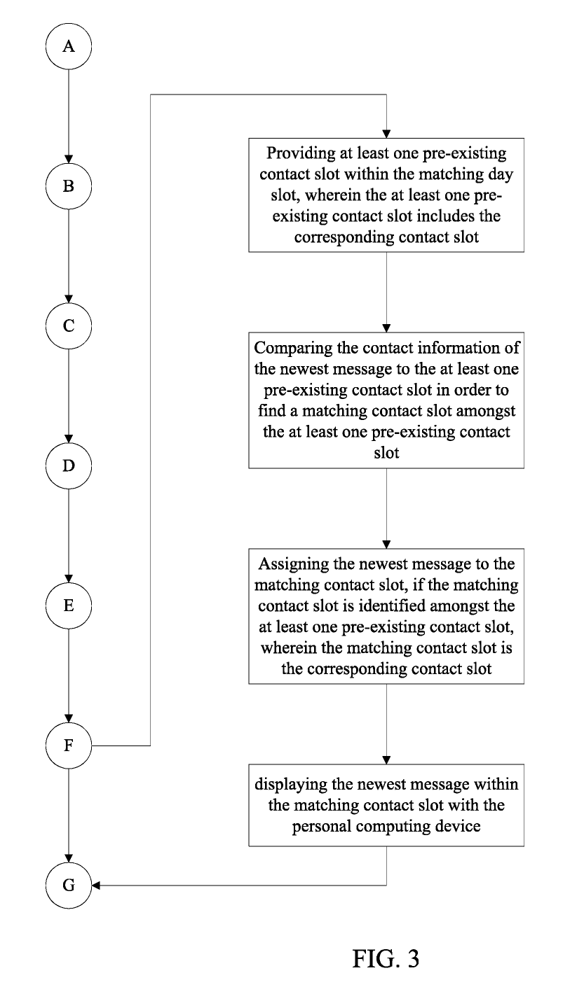

In reference to FIG. 3, when assigning the newest message to the corresponding contact slot, the newest message may be matched with an existing contact slot or placed into a newly generated contact slot. In order to match the newest message to a contact slot, at least one pre-existing contact slot is provided within the matching day slot, wherein the at least one pre-existing contact slot includes the corresponding contact slot. In order to find a matching contact slot amongst the at least one pre-existing contact slot, the remote server compares the contact information of the newest message to the at least one pre-existing contact slot. If the matching contact slot is identified amongst the at least one pre-existing contact slot, the newest message is assigned to the matching contact slot, wherein the matching contact slot is the corresponding contact slot. Otherwise, a new slot is generated. By assigning the newest message to the matching contact slot, the newest message can be grouped with other messages from the same contact. The personal computing device then displays the newest message within the matching contact slot such that all related messages may easily accessed.

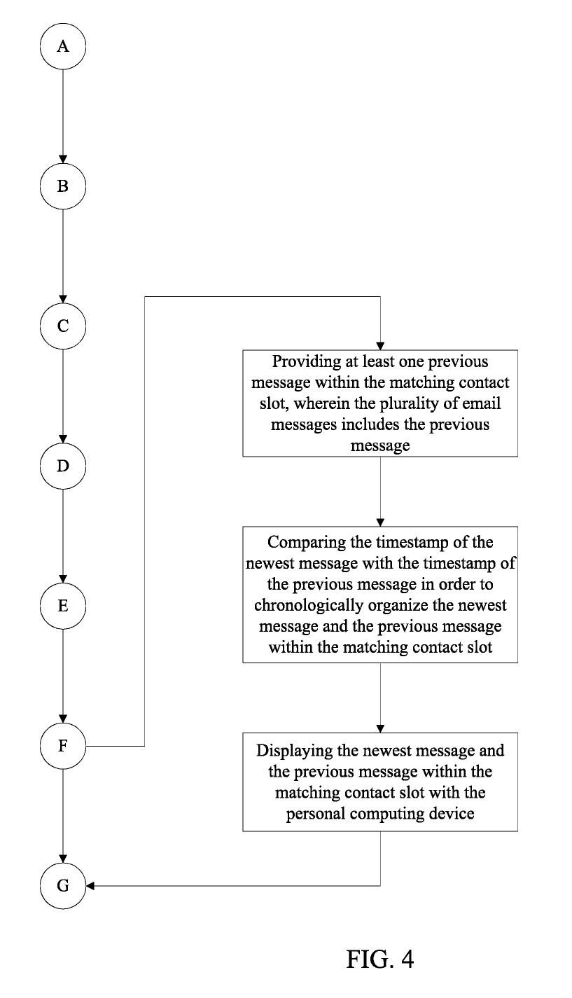

In reference to FIG. 4, the matching contact slot, by design, includes at least one previous message, wherein the plurality of email messages includes the previous message. In order to streamline the user experience, each message within the matching contact slot must be sorted into a logical order. In order to chronologically organize the newest message and the previous message within the matching contact slot, the timestamp of the newest message is compared with the timestamp of the previous message. In the preferred embodiment of the present invention, the timestamp includes date and time information in order to ensure each message is properly sorted. When accessed by a user, the newest message and the previous message are displayed within the matching contact slot with the personal computing device.

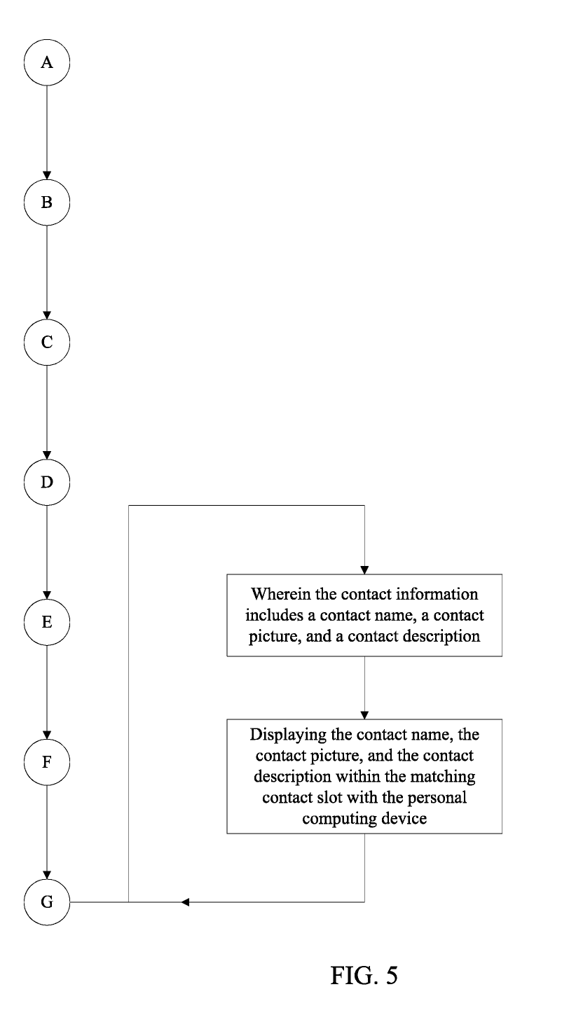

In reference to FIG. 5, in the preferred embodiment of the present invention, the contact information includes a contact name, a contact picture and a contact description. The contact name and the contact picture are used to easily distinguish messages from different people. The contact description may be used to note additional information about a contact, including the address of the contact, the occupation of the contact, or various other aspects. The contact name, the contact picture and the contact description are displayed within the matching contact slot with the personal computing device. This allows the user to easily identify each contact and access information about individual contacts.

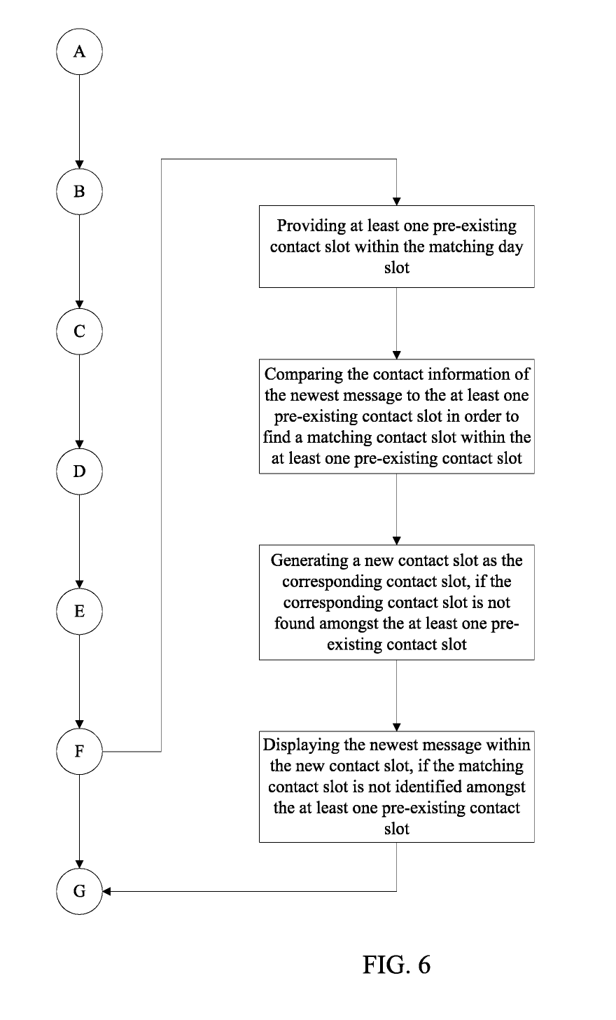

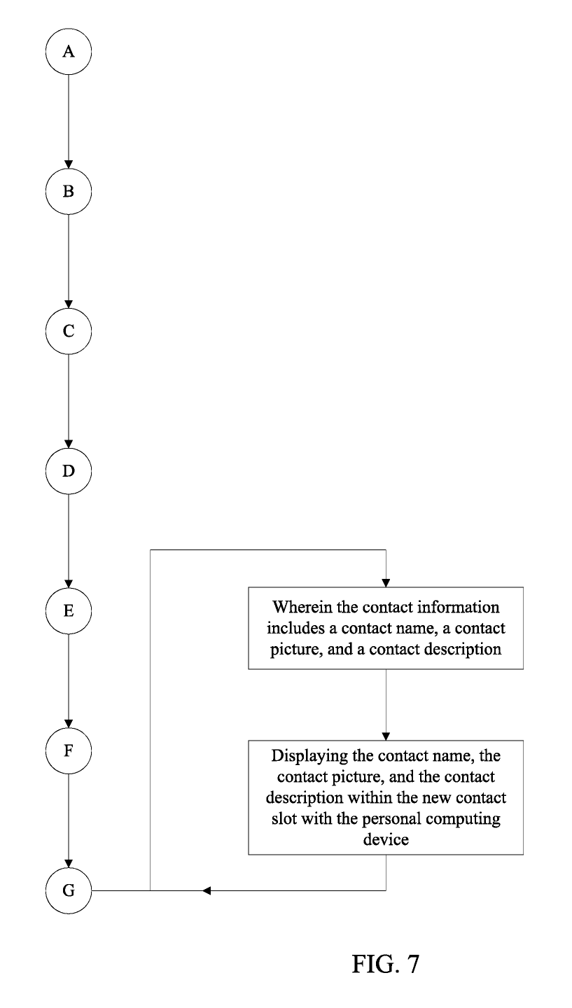

In reference to FIGS. 6-7, if the matching day slot contains no existing contact slots, a new contact slot is generated as the corresponding contact slot. If the matching day slot comprises at least one pre-existing contact slot, the remote server checks for a matching contact slot. In order to find a matching contact slot within the at least one pre-existing contact slot, the contact information of the newest message is compared to the at least one pre-existing contact slot. If the corresponding contact slot is not found amongst the at least one pre-existing contact slot, a new contact slot is generated as the corresponding contact slot. Further, if the matching contact slot is not identified amongst the at least one pre-existing contact slot, the newest message is displayed within the new contact slot. Similar to the matching contact slot, the contact name, the contact picture and the contact description are displayed within the new contact slot with the personal computing device. This allows the user to easily identify each contact and access information about individual contacts.

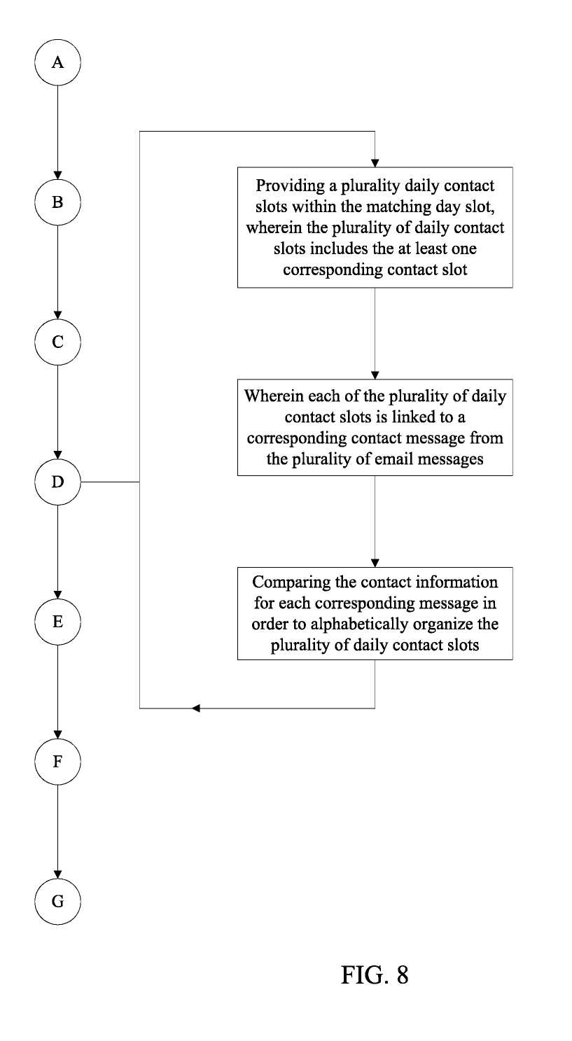

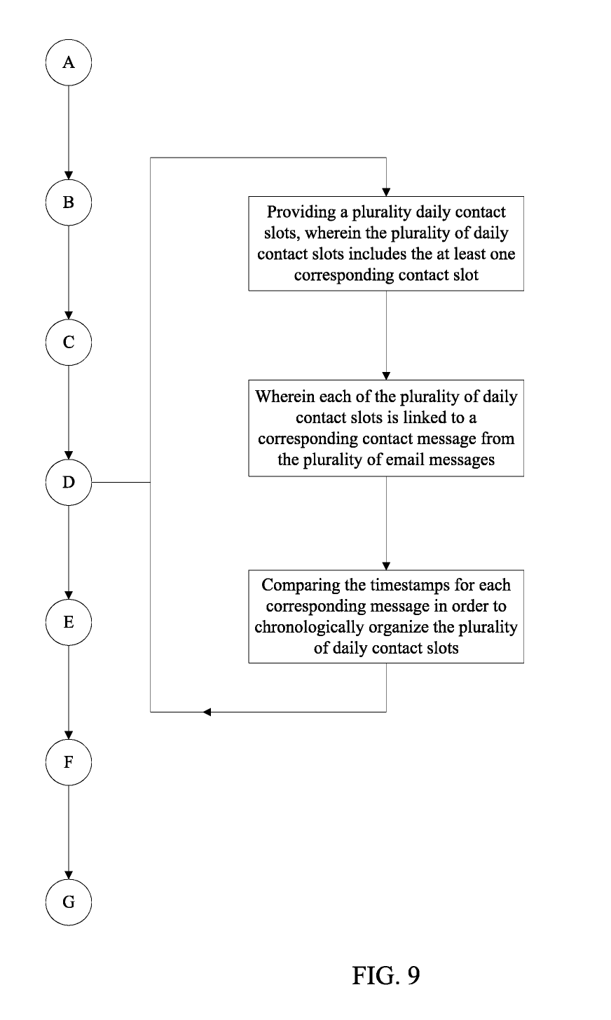

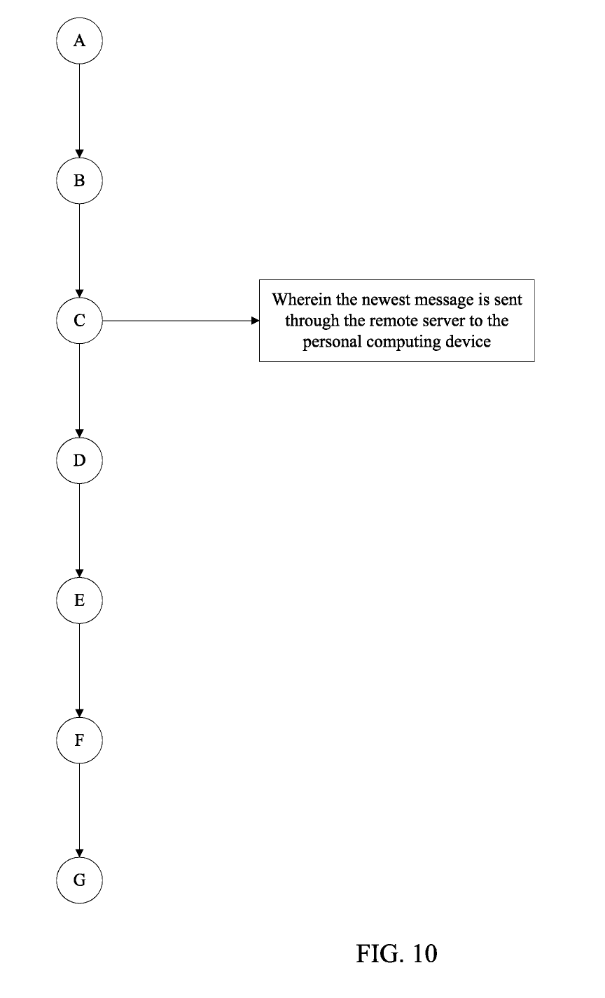

In reference to FIG. 8-9, the matching day slot includes a plurality of daily contact slots, wherein the plurality of daily contact slots includes the at least one corresponding contact slot. The number of daily contact slots depends on the number of email messages sent or received on a day corresponding to the matching day slot. Each of the plurality of daily contact slots is linked to a corresponding contact message from the plurality of email messages. The plurality of daily contact slots may be arranged in various ways. In the preferred embodiment of the present invention, the contact information for each corresponding message is compared in order to alphabetically organize the plurality of contact slots. Alternatively, the timestamps for each corresponding message may be compared in order to chronologically organize the plurality of daily contact slots. The plurality of day slots may also be organized based on the number of messages within each of the daily contact slots or may be organized to prioritize contact slots selected as “favorite” contact slots. Ultimately, the user is able to decide how each of the plurality of daily contact slots is organized.

In the preferred embodiment of the present invention, the personal computing device defaults to displaying the plurality of day slots for a current month. In reference to FIG. 12, when a selection request for a specific day slot is received with the personal computing device, the specific day slot is identified amongst the plurality of day slots with the remote server and is displayed with the personal computing device. This allows the user to view one or more contact slots within the specific day slot.

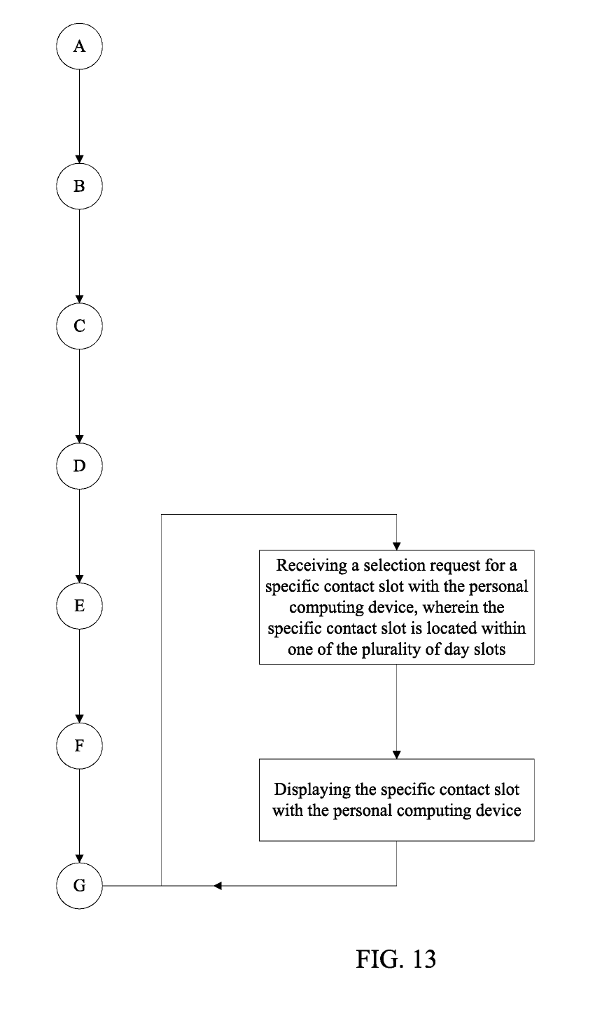

In reference to FIG. 13, while a user is navigating the virtual calendar, the user may decide to focus solely on messages form a certain contact. To do so, a selection request for a specific contact slot is received with the personal computing device, wherein the specific contact slot is located within one of the plurality of day slots. The specific contact slot is then displayed with the personal computing device.

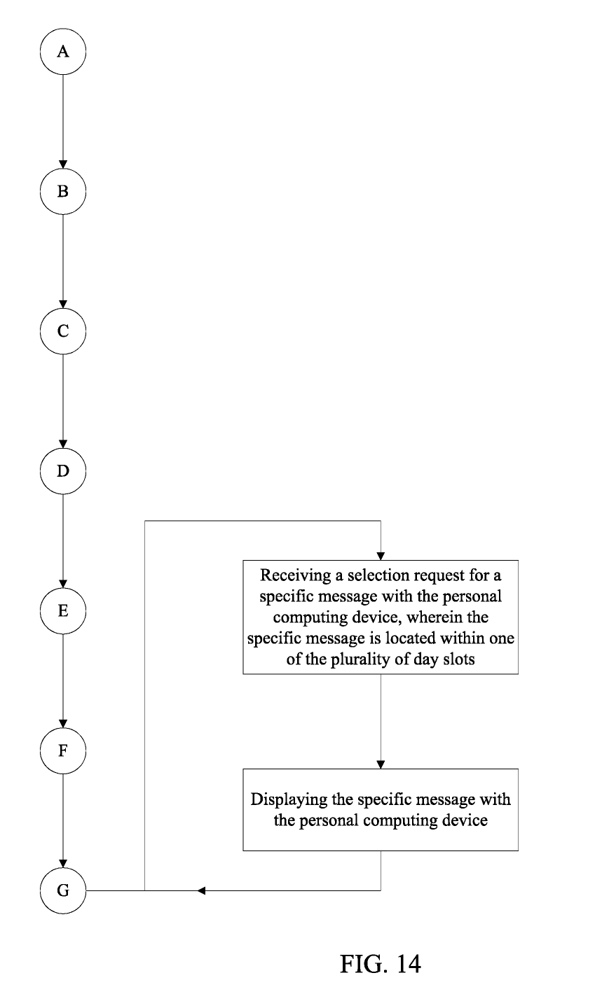

In reference to FIG. 14, while a user is navigating the virtual calendar, the user may decide to focus solely on one message. To do so, a selection request for a specific message is received with the personal computing device, wherein the specific message is located within one of the plurality of day slots. The arbitrary message is then displayed with the personal computing device.

Although the invention has been explained in relation to its preferred embodiment, it is to be understood that many other possible modifications and variations can be made without departing from the spirit and scope of the invention as hereinafter claimed.

What is claimed is:

1. A method of organizing emails, the method comprises the steps of:
(A) providing a personal computing device and at least one remote server;
(B) managing a virtual calendar with the remote server, wherein the virtual calendar includes a plurality of day slots;
(C) exchanging a plurality of email messages amongst the remote server and the personal computing device, wherein each email message includes contact information and a timestamp;
(D) comparing the timestamp of a newest message to the plurality of day slots with the remote server in order to find a matching day slot from the plurality of day slots, wherein the plurality of email messages includes the newest message;
(E) assigning the newest message to the matching day slot with the remote server;
(F) assigning the newest message to a corresponding contact slot within the matching day slot; and
(G) displaying the virtual calendar with the personal computing device.

2. The method of communicating to selected nodes in a mesh network as claimed in claim 1 comprises:
providing at least one pre-existing contact slot within the matching day slot, wherein the at least one pre-existing contact slot includes the corresponding contact slot;
comparing the contact information of the newest message to the at least one pre-existing contact slot in order to find a matching contact slot amongst the at least one pre-existing contact slot;
assigning the newest message to the matching contact slot, if the matching contact slot is identified amongst the at least one pre-existing contact slot, wherein the matching contact slot is the corresponding contact slot; and
displaying the newest message within the matching contact slot with the personal computing device.

3. The method of communicating to selected nodes in a mesh network as claimed in claim 2 comprises:
providing at least one previous message within the matching contact slot, wherein the plurality of email messages includes the previous message;
comparing the timestamp of the newest message with the timestamp of the previous message in order to chronologically organize the newest message and the previous message within the matching contact slot; and
displaying the newest message and the previous message within the matching contact slot with the personal computing device.

4. The method of communicating to selected nodes in a mesh network as claimed in claim 2 comprises:
wherein the contact information includes a contact name, a contact picture, and a contact description; and
displaying the contact name, the contact picture, and the contact description within the matching contact slot with the personal computing device.

5. The method of communicating to selected nodes in a mesh network as claimed in claim 1 comprises:
providing at least one pre-existing contact slot within the matching day slot;
comparing the contact information of the newest message to the at least one pre-existing contact slot in order to find a matching contact slot within the at least one pre-existing contact slot;
generating a new contact slot as the corresponding contact slot, if the corresponding contact slot is not found amongst the at least one pre-existing contact slot; and
displaying the newest message within the new contact slot, if the matching contact slot is not identified amongst the at least one pre-existing contact slot.

6. The method of communicating to selected nodes in a mesh network as claimed in claim 5 comprises:
wherein the contact information includes a contact name, a contact picture, and a contact description; and
displaying the contact name, the contact picture, and the contact description within the new contact slot with the personal computing device.

7. The method of communicating to selected nodes in a mesh network as claimed in claim 1 comprises:
providing a plurality daily contact slots within the matching day slot, wherein the plurality of daily contact slots includes the at least one corresponding contact slot;
wherein each of the plurality of daily contact slots is linked to a corresponding contact message from the plurality of email messages; and
comparing the contact information for each corresponding message in order to alphabetically organize the plurality of daily contact slots.

8. The method of communicating to selected nodes in a mesh network as claimed in claim 1 comprises:
providing a plurality daily contact slots, wherein the plurality of daily contact slots includes the at least one corresponding contact slot;
wherein each of the plurality of daily contact slots is linked to a corresponding contact message from the plurality of email messages; and
comparing the timestamps for each corresponding message in order to chronologically organize the plurality of daily contact slots.

9. The method of communicating to selected nodes in a mesh network as claimed in claim 1, wherein the newest message is sent through the remote server to the personal computing device.

10. The method of communicating to selected nodes in a mesh network as claimed in claim 1, wherein the newest message is sent from the personal computing device to the remote server.

11. The method of communicating to selected nodes in a mesh network as claimed in claim 1 comprises:
receiving a selection request for a specific day slot with the personal computing device;
identifying the specific day slot amongst the plurality of day slots with the remote server; and
displaying the specific day slot with the personal computing device.

12. The method of communicating to selected nodes in a mesh network as claimed in claim 1 comprises:
receiving a selection request for a specific contact slot with the personal computing device, wherein the specific contact slot is located within one of the plurality of day slots; and
displaying the specific contact slot with the personal computing device.

13. The method of communicating to selected nodes in a mesh network as claimed in claim 1 comprises:
receiving a selection request for a specific message with the personal computing device, wherein the specific message is located within one of the plurality of day slots; and
displaying the specific message with the personal computing device.
